(19) United States
(12) Patent Application Publication
(10) Pub. No.: US 2026/0274272 A1
(43) Pub. Date: Sep. 17, 2026

(54) Method and Driving Assistance Device for Occupancy-Grid-Based Predictive Support for an Automatic Vehicle Control, and Correspondingly Configured Motor Vehicle

(71) Applicant: Bayerische Motoren Werke Aktiengesellschaft, Muenchen (DE)

(72) Inventors: Jonas KURR, Muenchen (DE); Fabian PACHE, Muenchen (DE)

(21) Appl. No.: 19/474,200

(22) PCT Filed: Feb. 9, 2024
(86) PCT No.: PCT/EP2024/053385

§ 371 Date: Oct. 10, 2025

(30) Foreign Application Priority Data
Apr. 11, 2023 (DE) 10 2023 109 042.9

(51) Int. Cl. B60W 50/00; B60W 10/18; B60W 30/09; B60W 60/00; G05B 13/02

(52) U.S. Cl. CPC B60W 50/0097; B60W 10/18; B60W 30/09; B60W 60/001; G05B 13/0265; B60W 2050/0031; B60W 2530/201; B60W 2710/18; B60W 2720/10

(57) ABSTRACT

The invention relates to a method and to a driving assistance device for supporting control of a motor vehicle, and to a correspondingly configured motor vehicle. In a method, environmental data and position data of the motor vehicle are processed by a machine learning model which is trained to predict, on the basis of the data, a future movement state of the motor vehicle cell-wise in an occupancy grid. Then, using an output of the model, a deviation is determined between at least the most recent prediction which was output for the cell occupied by the motor vehicle and the current movement state of the motor vehicle and/or between at least a most recently output prediction and a corresponding earlier prediction. Based on the determined deviation, a decision is automatically made about a measure for the automatic control of the motor vehicle.

### BACKGROUND AND SUMMARY

The present invention lies in the field of motor vehicle technology. In this case, the invention relates to a method and a driving assistance device for carrying out or supporting automatic control of a motor vehicle. The invention also relates to a correspondingly configured motor vehicle.

Currently, an effort is increasingly being made to automate motor vehicles and vehicle functions and to equip motor vehicles with assistance systems which can automatically intervene in the driving operation of the respective motor vehicle, in particular for the purpose of improving safety. For this purpose, the relationship between the motor vehicle and its environment must typically be captured and analyzed, for example in order to avoid collisions with obstacles. However, the problem is that currently available systems, on the one hand, cannot always reliably detect or classify corresponding obstacles and, on the other hand, sometimes show so-called false positives, that is to say react to obstacles that are not present or are not relevant. Accordingly, there is still a need for improvements here.

As one approach, DE 11 2019 000 065 T5 describes a safety procedure analysis for avoiding obstacles in an autonomous vehicle. In this case, a movement path occupied by a vehicle and a movement path occupied by an object are generated at a particular time and a point of intersection between them is determined. On the basis of this, the vehicle can carry out a first safety procedure or an alternative procedure which, when it is implemented by the object when the object implements the second safety procedure, is determined as having a lower probability of causing a collision between the vehicle and the object in comparison with the first safety procedure.

As a further approach, DE 10 2020 100 685 A1 describes a prediction of temporal information in autonomous machine applications. A first output and a second output are calculated therein on the basis of image data using a sequential deep neural network. The first output corresponds to a speed in space of an object represented in an image of the sequence of images. The second output corresponds to a current location of the object and to a future location of the object in image space. In the method, an operation is then further carried out by a vehicle on the basis of at least the first output or the second output.

DE 11 2020 006 966 T5 deals with dynamic contextual road occupancy map perception for vulnerable road user safety in intelligent transport systems (ITS). In the method, a dynamic contextual road occupancy map is generated on the basis of collected sensor data. Furthermore, an awareness message regarding vulnerable road users is constructed and comprises a data field for sharing road occupancy map information. Furthermore, the awareness message is then transmitted and broadcast to a set of ITS stations, including one or more vulnerable road users.

An object of the present invention is to enable more reliable automated vehicle control.

This object is achieved by the subjects of the independent claims or the main claim and the coordinate claims. Further possible configurations of the invention are disclosed in the subclaims, the description and the figures. Features, advantages and possible configurations that are explained within the scope of the description for one of the subjects of the independent claims can be at least similarly considered to be features, advantages and possible configurations of the respective subject of the other independent claims and any possible combination of the subjects of the independent claims, possibly in conjunction with one or more of the subclaims.

A method according to the invention can be used to carry out or support automatic control or guidance of a motor vehicle. In a method step of a method according to the invention, sensor data from an environmental sensor system of the motor vehicle are captured, for example by a driving assistance system of the motor vehicle that is configured for the method. The sensor data can therefore describe or characterize or represent the respective environment, in particular obstacles detected therein and/or free spaces that can be driven through and/or the like. The sensor data may be or comprise, for example, data from a camera and/or a lidar device and/or a radar device and/or the like. The sensor data may be or comprise corresponding raw data and/or preprocessed data and/or data output by the environmental sensor system, for instance a list of objects and/or a semantic segmentation and/or the like.

In a further method step of a method according to the invention, vehicle data indicating a respective current movement state of the motor vehicle are captured-for example likewise by the driving assistance system. These vehicle data may indicate, in particular, the respective current speed and acceleration of the motor vehicle. Such vehicle data may be captured and/or retrieved, for example, from a vehicle electrical system or a corresponding control unit or the like.

In a further method step of a method according to the invention, position data indicating a respective current position of the motor vehicle are captured-for example likewise by the driving assistance system. This position may be present or may be indicated, for example, in a predefined vehicle-based coordinate system, that is to say in particular a coordinate system moving with the motor vehicle, or in a world-fixed coordinate system or the like or may be automatically converted into such a coordinate system. The position data may be retrieved, for example, from a positioning system, for example a navigation-satellite-based positioning system, of the motor vehicle.

Furthermore, in accordance with a method according to the invention, the respective environment of the motor vehicle has been or is subdivided into a multiplicity of cells, that is to say grid or raster cells, according to an occupancy grid or raster. This may mean, for example, that a corresponding occupancy grid or raster is computationally superimposed on the environment or is projected onto the environment and corresponding environmental data representing the environment are organized in or with such an occupancy grid or raster. The occupancy grid in the present sense is based on the motor vehicle, that is to say serves as the reference for predicted future positions of the motor vehicle itself. The occupancy grid therefore need not necessarily contain data, for instance positions or representations or trajectories or location probabilities or the like for other objects outside the vehicle, although this is possible.

In a further method step of a method according to the invention, the sensor data, the vehicle data and the position data are supplied as an input to a predefined machine learning model, that is to say a device, and are processed by the latter. This model is configured and trained to predict, that is to say forecast, on the basis of such an input, a respective future movement state of the motor vehicle in the respective cell in a cell-by-cell manner, that is to say for the individual cells of the occupancy grid, and to output corresponding predictions as an output. The model may be or comprise, in particular, a deep artificial neural network or the like. The occupancy grid or parameter of the occupancy grid, for instance a size and/or shape and/or arrangement of the occupancy grid and/or of the individual cells of the occupancy grid, may likewise be predefined, for example, and supplied to the model as part of the input or may have been integrated or implemented in the model during the construction or the training of the model or learnt by the model itself.

In a further method step of a method according to the invention, at the respective current time, on the basis of the output from the model, a deviation is determined. In one variant of the method according to the invention, this deviation can be determined as a deviation between at least the prediction last output by the model for the cell in which the motor vehicle is currently located in each case and the current, that is to say actual, movement state of the motor vehicle in this cell. In another variant of a method according to the invention, the deviation may be additionally or alternatively determined as a deviation between at least one prediction last output by the model for at least one cell, that is to say for example the output last output by the model, and an earlier prediction or an earlier output from the model for the same cell or a cell covering the same spatial area. In other words, it is therefore possible to determine, by means of a corresponding comparison, whether the motor vehicle moves according to the prediction from the model and/or whether there has been a change or drift in the predictions over the course of time or at least since the last prediction from the model, that is to say a different movement state of the motor vehicle is predicted now than at an earlier time. Such deviations may indicate an uncertainty or incorrect assessment of automatic systems or devices of the motor vehicle and/or may be used as at least an indication or parameter for identifying critical situations.

Such a critical situation may be, in particular, a situation in which a collision between the motor vehicle and an obstacle or the like is imminent or can be expected with at least a predefined minimum probability, for example without a corresponding reaction. In particular, such a critical situation can be identified when, at a particular time, the speed and/or acceleration of the motor vehicle predicted for the immediate future and/or the actual speed and/or acceleration of the motor vehicle at this time is/are higher than in an earlier output from the model for this time. Such a deviation may at least indicate an increased probability of the motor vehicle being in a critical situation and may be taken into account as a factor increasing this probability in a further data processing or decision-making process, that is to say ultimately the control of the motor vehicle. Since the model need not necessarily be trained to identify such deviations, but rather to predict the actual movement state of the motor vehicle as accurately and reliably as possible, the model should have learnt to predict a normal behavior or a standard behavior of the motor vehicle outside critical situations, since the motor vehicle is typically in non-critical normal or standard situations and not in a critical situation during the majority of its operating time. Accordingly, deviations, in particular upward deviations, from the predicted movement state may be deemed to be a sign or indication of situations that are outside the normal case and are therefore at least potentially critical.

In a further method step of a method according to the invention, a decision is automatically made about a measure for automatically controlling or guiding the motor vehicle at least on the basis of the respectively determined deviation and such a measure is carried out or initiated. In other words, the deviation may be included as a parameter, in particular as one of a multiplicity of parameters, in a corresponding predefined decision-making algorithm or a predefined decision-making or vehicle guidance model or a corresponding operating or computer program. Therefore, it is possible to decide-at least also-on the basis of the determined deviation or its magnitude, for example, whether emergency braking should be carried out or whether an intervention threshold of an assistance system for carrying out or supporting the control or guidance of the motor vehicle is increased or reduced or maintained without change and/or the like.

The procedure proposed here may act as a type of self-monitoring mechanism of the motor vehicle and may result in improved identification of critical situations, in particular in at most partially automated or at most supported or assisted driving operation of the motor vehicle. The present invention can therefore ultimately enable or improve reliable operation or intervention of assistance systems for supporting a driver when guiding or controlling the respective motor vehicle. This may ultimately result in or contribute to improved safety in traffic situations. The use of the occupancy grid proposed here may make it possible to implement or carry out the method according to the invention in a particularly simple, robust and efficient manner. For example, with an appropriate size of the cells, on account of the cell-by-cell consideration, deviations on account of measurement inaccuracies or with fluctuations or shifts in the real trajectory of the motor vehicle that are not significant or are not relevant to safety and are conventional or unavoidable during the at least partially manual vehicle guidance, for example in comparison with an ideal trajectory, or the like can remain automatically disregarded or can be averaged out. This may therefore result in or contribute to avoiding or reducing false positives for critical situations or relevant deviations and may therefore result in or contribute to improved robustness of the method and/or a reduced data processing effort.

The present invention also relates to a driving assistance device for a motor vehicle. This may be, in particular, the driving assistance device mentioned in connection with a method according to the invention. A driving assistance device according to the invention has an input interface for capturing sensor data, vehicle data and position data. These may therefore likewise be, in particular, the data mentioned in connection with the method according to the invention. A driving assistance device according to the invention also has a machine learning model or the model mentioned in connection with the method according to the invention which is configured and trained to predict, on the basis of the captured data, for individual cells of an occupancy grid of the environment, a respective future movement state of the motor vehicle in a cell-by-cell manner and to output corresponding predictions as an output. The driving assistance device also has an output interface, for example for outputting the output from the model and/or a processing result determined on the basis thereof by the driving assistance device or a corresponding control signal.

A driving assistance device according to the invention is configured for use in a method according to the invention. The driving assistance device can therefore be configured, in particular, to output or provide the cell-by-cell predictions or the occupancy grid provided with the predictions. Corresponding outputs from the driving assistance device can then be used or further processed, for example, by a further device or another assistance system of the respective motor vehicle. The driving assistance device according to the invention may likewise be configured to determine in each case the deviations described in connection with the method according to the invention on the basis of the output from the model. The driving assistance device can then output or provide the determined deviation or a corresponding deviation signal that signals such a deviation. The driving assistance device itself may likewise be configured to automatically make a decision about the measure for automatically controlling the motor vehicle at least on the basis of the determined deviation or also to initiate the corresponding measure, if necessary, for example by outputting a corresponding control signal or the like. Depending on the configuration or range of functions of the driving assistance device, the input interface and/or the output interface may be combined or separate and may each be formed completely or partially in hardware and/or in software.

In one possible configuration of the present invention, the driving assistance device is configured to determine the deviation, to compare it with a predefined significance threshold value and to output a corresponding comparison result. Such a comparison result may be output, for example, to a device of the motor vehicle downstream of the driving assistance device in the data processing or decision-making pipeline in accordance with the method according to the invention or to an accordingly downstream program module of the driving assistance device or the like. For example, the driving assistance device may be configured to output or use the deviation as the parameter to be taken into account for the ultimate decision or to classify and/or handle the deviation as different from zero or as critical or the like only when the deviation corresponds at least to the significance threshold value, that is to say reaches or exceeds it. This makes it possible to save data processing effort, if appropriate, and/or to avoid or reduce an expenditure of insignificant deviations on the ultimate decision or control of the motor vehicle. This therefore makes it possible to ultimately operate a driving assistance device in a particularly efficient and/or robust manner and to use a method according to the invention in a particularly robust and/or efficient manner.

In a further possible configuration of the present invention, a driving assistance device is configured to take into account a plurality of earlier predictions from the model in order to determine the deviation. In other words, not only the respective immediately preceding prediction can therefore be taken into account, for example, but rather a plurality of corresponding prediction time steps or a corresponding prediction history can be taken into account. For this purpose, a sliding average value or average of a plurality of earlier predictions may be formed, for example, and may be compared with the current prediction and/or with the current movement state of the motor vehicle. This makes it possible to reduce an influence of noise or random fluctuations or uncertainties or instabilities of the model on the ultimate decision or the control of the vehicle. This makes it possible to achieve an accordingly more robust and reliable or more consistent behavior of the motor vehicle and to avoid an erratic or quickly or suddenly changing behavior.

In a further possible configuration of the present invention, a driving assistance device is also configured to determine, for each cell of the occupancy grid, a probability of the motor vehicle driving through the respective cell, that is to say a respective future location probability of the motor vehicle in the respective cell. The driving assistance device is then also configured to provide or use these cell-by-cell probabilities for consideration for the decision. For example, determined deviations may be weighted with or on the basis of the respective probability, wherein deviations determined for cells with a greater location probability may be given a higher weighting than deviations determined for cells with a lower location probability. The future movement states of the motor vehicle may also be reduced, for example, only for cells with probabilities of greater than zero. This can save corresponding computing or data processing effort. The consideration of the location probabilities for the motor vehicle, as proposed here, may also enable even more robust and reliable operation of the driving assistance device or of the motor vehicle overall.

In a further possible configuration of the present invention, a driving assistance device is configured to also determine or capture an automatically planned trajectory, that is to say a trajectory extending for example from the respective current time into the future, and/or speed planning of the motor vehicle. The driving assistance device is then also configured to supply this planned trajectory and/or this speed planning to the model as an input for predicting the future movement states of the motor vehicle. The assistance device may therefore likewise be configured here to process such a planned trajectory and/or speed using the model. The planned trajectory and/or speed planning may be determined, for example, by the driving assistance device itself, that is to say for instance a corresponding different program module, and can then be captured, for example, via an internal interface of the driving assistance device and can be transferred to the model. The planned trajectory and/or the speed planning may likewise be captured by the driving assistance device via an external interface if the planned trajectory or speed planning was determined, for example, by another device of the motor vehicle. The consideration of the planned trajectory and/or the speed planning, as proposed here, may enable more accurate and more reliable predictions of the movement state of the motor vehicle and/or more efficient operation of the driving assistance device or of the model or faster execution of the model, that is to say faster generation of the predictions. More time may therefore possibly be available for a corresponding reaction, which can enable further improved safety.

In a further possible configuration of the present invention, a driving assistance device is configured to also capture attentiveness data and to supply them to the model as an input for predicting the future movement states of the motor vehicle. In this case, the attentiveness data indicates or characterizes the attentiveness of the driver. The attentiveness data may therefore indicate or characterize, for example, a viewing direction or an attentiveness area and/or a degree of distraction and/or a degree of fatigue of the driver and/or the like. The attentiveness data may be determined, for example, by the driving assistance device itself, that is to say a corresponding different program module and/or a corresponding sensor system of the driving assistance device, and can then captured, for example, via an internal interface of the driving assistance device and transferred to the model. The attentiveness data may likewise be captured by the driving assistance device via an external interface if the attentiveness data were determined, for example, by another device of the motor vehicle, for instance a driver observation device or the like.

The consideration of the attentiveness data, as proposed here, may enable more accurate and more reliable predictions of the movement state of the motor vehicle. For example, when the gaze or attentiveness of the driver is directed to an obstacle in the direction of travel of the motor vehicle and/or the degree of fatigue of the driver is relatively low, earlier or timely braking can be expected and therefore an accordingly lower speed and/or weaker acceleration of the motor vehicle ahead of the obstacle can be predicted than when the gaze or attentiveness of the driver is directed to another area or is distracted by the surrounding traffic situation and/or the degree of fatigue of the driver is higher. The significance threshold value mentioned at another point and/or a weighting of a determined deviation may likewise be automatically adapted, for example, on the basis of the attentiveness data. For example, a higher significance threshold value and/or a lower weighting can be used when the attentiveness of the driver is higher with respect to the traffic situation in the respective cell.

In a further possible configuration of the present invention, a driving assistance device is configured to set or select the size of the cells of the occupancy grid on the basis of the geographical position and/or the type of the respective environment and/or the size of the motor vehicle. For this purpose, a corresponding rule and/or a corresponding collection of different occupancy grids or corresponding parameters of the occupancy grid may be predefined, for example. Predefined map data and/or navigation data may likewise be used or taken into account, for example, for the purpose of setting or selecting the size of the cells of the occupancy grid. The variable or dynamically adaptable size of the cells of the occupancy grid, as proposed here, can enable particularly accurate, reliable and robust predictions and/or can reduce computing effort in accordingly different situations or applications.

For example, if the road course ahead has more bends and/or in areas with a multiplicity of possible routes or trajectories starting from the current position of the motor vehicle, for example in intersection areas or inner-city areas, smaller cell sizes can be used than in other areas, for example a freeway or a portion of a highway without turnoffs or the like. Smaller cell sizes can likewise be used, for example, in areas with a greater risk potential than in areas with a lower risk potential. A greater risk potential may be given, for example, by the presence or the possibility of oncoming traffic, in particular without a structural separation between lanes or the like provided for different directions of travel and immediately adjacent to one another. With a smaller cell size, deviations may possibly be identified earlier or in more detail in such situations, which can enable an earlier reaction and therefore greater safety. In contrast, in other areas, the computing or data processing effort can often be reduced by a larger cell size without reducing safety. Different cell sizes can be used for different vehicle sizes, that is to say for example different vehicle types, such that at least the respective motor vehicle fits completely into a cell. Discrete prediction steps can therefore be clearly and unambiguously enabled, since the motor vehicle or its position can be respectively uniquely assigned to a particular cell of the occupancy grid.

In a further possible configuration of the present invention, a driving assistance device is configured to make a decision about carrying out an automatic braking maneuver, in particular emergency braking, as a measure for automatically controlling or guiding the motor vehicle on the basis of the determined deviation. For example, the driving assistance system may be configured to decide to initiate or carry out an automatic braking maneuver or to implement this decision when the prediction or the corresponding comparison reveals that the speed of the motor vehicle is not falling as quickly as predicted, in particular not quickly enough for avoiding a collision without an automatic braking intervention, or the like. The application proposed here for an automatic brake system or an automatic emergency brake assistant may constitute a particularly beneficial and effective application for the present invention. Automatic braking maneuvers carried out correctly can contribute significantly to improved safety, whereas automatic braking maneuvers carried out incorrectly, that is to say unnecessarily or inappropriately, may possibly reduce the overall safety in a particular traffic situation. Since the present invention can improve improved identification of actually critical situations that may require or justify an automatic braking intervention or an automatic braking maneuver, particularly effective improvement of the safety in traffic situations can therefore be achieved here.

Measures or processes mentioned in connection with a driving assistance device according to the invention or its configurations or developments may form further, possibly optional, method steps of the method according to the invention.

The present invention also relates to a motor vehicle having an environment sensor system for recording and providing environmental data and the driving assistance device according to the invention. A motor vehicle according to the invention is configured to automatically control at least one vehicle function on the basis of a data processing result of the driving assistance device. In other words, the motor vehicle according to the invention may be configured to carry out or use the method according to the invention, in particular automatically. A motor vehicle according to the invention may therefore be or correspond to, in particular, the motor vehicle mentioned in connection with the method according to the invention and/or in connection with the driving assistance device according to the invention.

Further features of the invention may emerge from the claims, the figures and the description of the figures. The features and combinations of features mentioned above in the description and the features and combinations of features shown below in the description of the figures and/or in the figures alone can be used not only in the respectively stated combination but also in other combinations or alone, without departing from the scope of the invention.

### BRIEF DESCRIPTION OF THE DRAWINGS

FIG. 1 shows a schematic overview illustration having a motor vehicle in an environment for illustrating a method for automated vehicle control; and

FIG. 2 shows an exemplary schematic flowchart for a corresponding method.

### DETAILED DESCRIPTION OF THE DRAWINGS

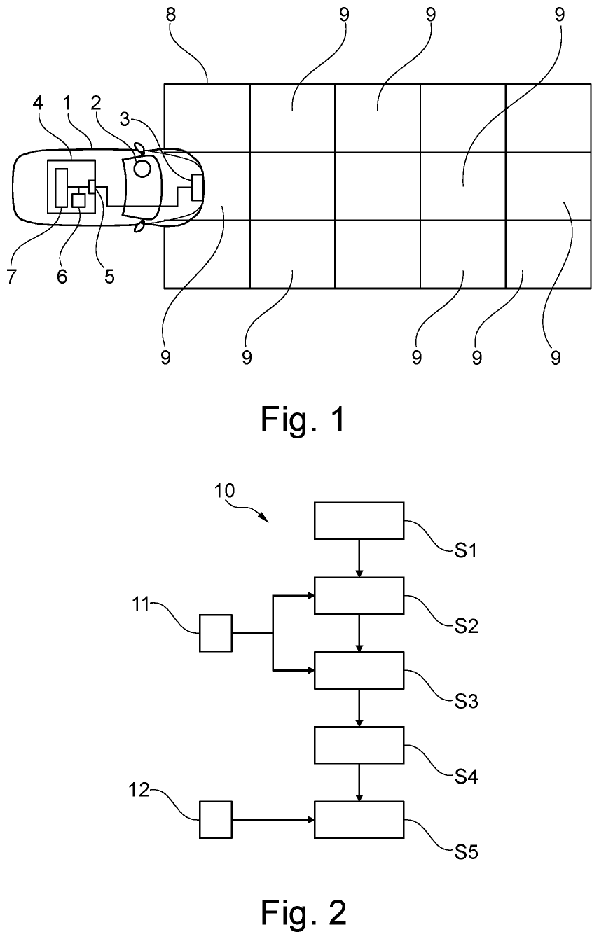

There are already a multiplicity of approaches and assistance systems for improving safety in traffic situations. It is problematic or important in this case to optimize the performance in dangerous situations without increasing the rate of false positives, that is to say inappropriate automated measures or interventions in the respective situation. More information may be worthwhile or decisive for this purpose. Such additional information may lie in the prediction of a future movement state of a vehicle or in the assessment or checking of the correctness of such a prediction. In this respect, FIG. 1 shows a partial schematic illustration of a motor vehicle 1 which can be controlled by a driver 2, for example in partially automated or supported or assisted driving operation. The motor vehicle 1 has an environmental sensor system 3 for capturing a respective environment of the motor vehicle 1 and a driving assistance system 4 coupled thereto. The driving assistance system 4 can capture data via an interface 5, for example from a vehicle electrical system of the motor vehicle 1. Depending on the configuration, different data and/or signals may be captured or output via this interface 5. The driving assistance device 4 also has data processing means which are schematically represented here by a processor 6, that is to say for example a microchip, a microcontroller or a microprocessor or the like, and a data memory 7 coupled thereto. A predefined trained machine learning model, as well as an operating or computer program, may be implemented or stored in the data memory, for example, and may be executed by means of the processor 6. A method described below for carrying out or supporting at least partially automated guidance or control of the motor vehicle 1 can therefore be carried out in an automated manner.

In order to illustrate such a method, FIG. 2 shows an exemplary schematic flowchart 10. In the corresponding method, data can be captured by the driving assistance system 4, for example via the interface 5, in a method step S1. These data may comprise, for example, sensor data from the environmental sensor system 3 as well as vehicle data indicating the current movement state of the motor vehicle 1 and position data indicating a current position of the motor vehicle 1.

In a method step S2, a future location probability of the motor vehicle 1 at different locations may be determined or predicted, for example, by the driving assistance system 4 or a further assistance system of the motor vehicle 1 and/or may be captured by the driving assistance system 4. For this purpose, an occupancy grid 8 which is schematically indicated in FIG. 1 and according to which the respective environment of the motor vehicle 1 can be subdivided into individual cells 9 may be predefined. In a practical implementation, the occupancy grid 8 may extend over a relatively larger area than illustrated here. For the sake of clarity, however, only a limited number of cells 9 are described and explicitly indicated here. The cells 9 of the occupancy grid 8 may be of a predefined constant size or may have different sizes in different situations or applications. For example, the side lengths of the cells 9 may be in the range or of the order of magnitude of approximately 10 cm to 1 m or several meters. The future location probability of the motor vehicle 1 can be individually determined or predicted automatically for each of the cells 9. These location probabilities may be determined or predicted on the basis of the data captured in method step S1 and/or on the basis of an additional input 11 indicated schematically here, that is to say further input data.

In a method step S3, for the individual cells 9, a respective future movement state of the motor vehicle 1 in the respective cell 9 is predicted using the predefined machine learning model of the driving assistance system 4 at least on the basis of the data captured in method step S1 or on the basis of at least part of the additional input 11 or a further additional input 11. This can be carried out, for example, taking into account the respective location probability and/or data relating to the attentiveness of the driver 2 captured for example as part of the additional input 11, a behavioral or driving history of the motor vehicle 1 or of corresponding vehicles and/or automatic trajectory and/or speed planning and/or objects identified in the respective environment and/or the like. The corresponding prediction of the location probabilities and of the movement state or the future movement states of the motor vehicle 1 can be repeated regularly during operation of the motor vehicle 1. In this case, both a respective current prediction and one or more earlier or older predictions may be buffered, that is to say held, in the data memory 7, for example.

In a method step S4, a deviation can then be determined or a check for a presence of a deviation can then be carried out on the basis of a corresponding output from the machine learning model. In this case, a deviation between the prediction for the current time and the actual current movement state of the motor vehicle 1 can be determined. Additionally or alternatively, a deviation between one or more older or earlier predictions and the respective current prediction can be determined.

A possibly determined deviation may likewise be processed further and/or analyzed here, for example by means of a weighting and/or by forming a sliding average value or average and/or by comparison with a predefined threshold value for the purpose of determining the significance of the deviation and/or the like.

In a method step S5, the motor vehicle 1 or at least one function of the motor vehicle 1 can then be automatically controlled at least also on the basis of the possibly determined deviation or its magnitude. A decision can be made, for example, about carrying out an automatic control intervention, for instance a braking intervention or the like, and such an intervention may possibly be initiated or carried out. In addition to the determined deviation, one or more further decision parameters 12 may also be included in such a decision and/or control in order to be able to make a decision that is as robust and reliable and sound as possible and to enable corresponding vehicle control. For example, a determined deviation indicating that the actual speed and/or acceleration of the motor vehicle 1 or the currently or last predicted speed and/or acceleration of the motor vehicle 1 is/are greater than an earlier or older corresponding prediction can be taken into account or included in the decision for the purpose of identifying a critical situation and therefore initiating an automatic braking intervention, for example, or preparing for such an intervention or reducing a corresponding intervention threshold and/or the like.

Overall, the described examples show how machine learning can be used to predict a movement state, in particular the speed and acceleration, of a vehicle in a raster or grid in front of the respective vehicle for the purpose of identifying safety risks.

### LIST OF REFERENCE SIGNS

1 Motor vehicle
2 Driver
3 Environmental sensor system
4 Driving assistance system
5 Interface
6 Processor
7 Data memory
8 Occupancy grid
9 Cell
10 Flowchart
11 Additional input
12 Decision parameter
S1-S5 Method steps

1-10. (canceled)

11. A method for supporting automatic control of a motor vehicle, comprising:
capturing sensor data from an environmental sensor system of the motor vehicle;
capturing vehicle data indicating a current movement state of the motor vehicle;
capturing position data indicating a current position of the motor vehicle;
subdividing an environment of the motor vehicle into a multiplicity of cells according to an occupancy grid;
supplying the sensor data, the vehicle data and the position data as an input to a predefined machine learning model which is configured and trained to predict, on the basis thereof, a respective future movement state of the motor vehicle in the respective cell in a cell-by-cell manner and to output corresponding predictions as an output;
determine a deviation, at the respective current time, on a basis of the output from the model, wherein the deviation is determined between at least one of:
at least the prediction last output by the model for the cell in which the motor vehicle is currently located and the current movement state of the motor vehicle; or
at least one prediction last output by the model for at least one cell and an earlier prediction by the model for the same cell or a cell covering the same spatial area; and
automatically determining a measure for automatically controlling the motor vehicle at least on the basis of the determined deviation.

12. A driving assistance device for a motor vehicle, comprising:
an input interface configured to capture sensor data, vehicle data and position data;
a machine learning model which is configured and trained to predict, on the basis thereof, for individual cells of an occupancy grid of the environment, a respective future movement state of the motor vehicle in the respective cell in a cell-by-cell manner and to output corresponding predictions as an output; and
an output interface;
wherein the driving assistance device is configured for use in the method according to claim 11.

13. The driving assistance device according to claim 12, wherein:
the driving assistance device is configured to determine the deviation, to compare the deviation with a predefined significance threshold value, and to output a corresponding comparison result.

14. The driving assistance device according to claim 12, wherein:
the driving assistance device is configured to take into account a plurality of earlier predictions from the model in order to determine the deviation.

15. The driving assistance device according to claim 12, wherein:
the driving assistance device is configured to determine, for each cell of the occupancy grid, a probability of the motor vehicle driving through the respective cell and to provide these cell-by-cell probabilities for consideration for the decision.

16. The driving assistance device according to claims 12, wherein:
the driving assistance device is configured to capture at least one of an automatically planned trajectory or speed planning of the motor vehicle and to supply the captured at least one of an automatically planned trajectory or speed planning of the motor vehicle to the model as an input for predicting the future movement states of the motor vehicle.

17. The driving assistance device according to claim 12, wherein:
the driving assistance device is configured to capture attentiveness data characterizing the attentiveness of the driver of the motor vehicle and to supply the captured attentiveness data to the model as an input for predicting the future movement states of the motor vehicle.

18. The driving assistance device according to claim 12, wherein:
the driving assistance device is configured to select the size of the cells of the occupancy grid on the basis of at least one of the geographical position, the type of the respective environment, or the size of the motor vehicle.

19. The driving assistance device according to claim 12, wherein:
the driving assistance device is configured to make a decision about carrying out an automatic braking maneuver, in particular emergency braking, as a measure for automatically controlling the motor vehicle on the basis of the determined deviation.

20. A motor vehicle, comprising:
an environment sensor system and a driving assistance device according to claim 12;
wherein the motor vehicle is configured to automatically control at least one vehicle function on the basis of a data processing result of the driving assistance device.
